(19) United States
(12) Patent Application Publication
(10) Pub. No.: US 2015/0145472 A1
(43) Pub. Date: May 28, 2015

(54) MOTOR VEHICLE HAVING AN ENERGY STORAGE DEVICE

(71) Applicant: FORD GLOBAL TECHNOLOGIES, LLC, Dearborn, MI (US)

(72) Inventors: Donatus Andreas Josephine KEES, Billericay Essex (GB); Anthemios Philemon PETRIDIS, Bishop's Stortford (GB)

(21) Appl. No.: 14/542,055

(22) Filed: Nov. 14, 2014

(30) Foreign Application Priority Data
Nov. 26, 2013 (GB) 1320806.1

(51) Int. Cl. B60L 11/18

(52) U.S. Cl. CPC B60L 11/1829
USPC 320/108

(57) ABSTRACT

A motor vehicle is disclosed having an energy storage device that is replenished with energy by inductive coupling with a fixed inductive charging point using a vehicle mounted inductive coupling member. A three dimensional positioning mechanism is used to position the inductive coupling member so that it is aligned with and positioned in close proximity to the fixed charging point thereby ensuring a high coupling efficiency between the inductive coupling member and the fixed charging point. The use of a three dimensional positioning mechanism has the advantage that the inductive coupling member can be positioned accurately without the need to position the motor vehicle accurately.

### CROSS-REFERENCE TO RELATED APPLICATION

This application claims foreign priority benefits under 35 U.S.C. §119(a)-(d) to GB 1320806.1 filed Nov. 26, 2013, which is hereby incorporated by reference in its entirety

### TECHNICAL FIELD

This invention relates to motor vehicles and in particular to a motor vehicle having an energy storage device in which replenishment of the energy storage device is performed by inductive coupling with a fixed inductive charging point. A fixed charging point is a point where a coil or coils connected to a source of electrical energy is located for use in inductive coupling with secondary coil mounted on the motor vehicle.

### BACKGROUND

It is known from, for example, US Patent Publication 2007/0131505 to provide a motor vehicle with a mechanism to assist with positioning an inductive coupling member located on the vehicle in close proximity to a fixed inductive charging point in order to provide an efficient inductive coupling therebetween.

It is a problem with the mechanism disclosed in US Patent Publication 2007/0131505 that the driver of the motor vehicle has to very accurately position the motor vehicle in order for efficient inductive coupling to be made. This positioning is extremely difficult to achieve due partly to the fact that for efficient inductive coupling to occur the inductive coupling member has to be positioned in close proximity to the fixed charging point and also has be very accurately aligned with the fixed charging point and partly due to the fact that the fixed charging point is not visible to the driver of the motor vehicle due to its location on the ground. Positioning a vehicle with the degree of accuracy required is therefore extremely difficult for even a very experienced driver to achieve. Any misalignment between the fixed charging point and the inductive coupling member will inevitably result in a loss of inductive coupling efficiency which may result in excessive cost for the energy transferred, a very long charging time to replenish the energy level to a required level or a failed charge cycle.

It is an object to provide a motor vehicle in which efficient inductive coupling between a fixed charging point and a vehicle mounted inductive coupling member can be achieved without the need for accurate positioning of the motor vehicle.

### SUMMARY

According to a first aspect of the invention there is provided a motor vehicle having a body structure, an energy storage device and an inductive charging system to selectively replenish the energy storage device by connecting the energy storage device to a source of electrical power by means of inductive coupling with a fixed ground located inductive charging point wherein the inductive charging system comprises an inductive coupling member and a three dimensional positioning mechanism arranged to support the inductive coupling member and operable to position the inductive coupling member so that the inductive coupling member is aligned with and positioned in close proximity to the fixed charging point so as to facilitate replenishment of the energy storage device via the inductive coupling member.

The positioning mechanism may be located underneath the motor vehicle between a floor of the motor vehicle and a surface upon which the motor vehicle is resting.

The positioning mechanism may be operable to position the inductive coupling member so that the inductive coupling member is aligned with and positioned in close proximity to the fixed charging point when replenishment is requested by a user of the motor vehicle.

The positioning mechanism is automatically controlled to position the inductive coupling member aligned with and in close proximity to the fixed charging point.

The inductive coupling member is positioned in close proximity to the fixed charging point such that there is no air-gap between the inductive coupling member and the fixed charging point.

The positioning mechanism may include a first carriage moveable in a longitudinal direction of the motor vehicle, a second carriage mounted on the first carriage for movement in a transverse direction of the motor vehicle and a lift mechanism attached to the second carriage to vary the vertical position of the inductive coupling member.

The mechanism to vary the vertical position of the inductive coupling member may comprise at least one arm pivotally connected at one end to the second carriage and connected at an opposite end to the inductive coupling member.

The mechanism may comprises a pair of arms each of which is pivotally connected at a respective one end to the second carriage and connected at a respective opposite end to the inductive coupling member so as to form in combination with the second carriage and the inductive coupling member a four bar linkage.

Alternatively, the mechanism to vary the vertical position of the inductive coupling member may comprise a rotatable turret rotatably supported by the second carriage and an extendable arm connected at one end to the rotatable turret and connected at an opposite end to the inductive coupling member.

As yet another alternative, the positioning mechanism may comprise a rotatable turret and at least one extendable arm pivotally connected at one end to the rotatable turret and connected at an opposite end to the inductive coupling member.

The vehicle may further comprise at least three induction sensors positioned at known positions on an underside of the vehicle and an electronic controller arranged to receive outputs from the induction sensors and determine using the sensor outputs the position of the fixed charging point relative to a current position of the inductive coupling member.

The electronic controller may be further operable to provide one or more control outputs to actuators formed as part of the three dimensional positioning mechanism for use in controlling the position of the inductive coupling member.

The electronic controller may be operable when requested to move the inductive coupling member towards the fixed ground mounted inductive charging point.

Alternatively, the vehicle may further comprise at least three cameras positioned on an underside of the vehicle, a display screen to display outputs from the cameras and a human machine interface to provide a control input to an electronic controller arranged to control the position of the inductive coupling member in response to the input from the human machine interface.

In which case, the electronic controller may be operable to provide control outputs to actuators formed as part of the three dimensional positioning mechanism in order to control the position of the inductive coupling member.

The inductive coupling member may include a number of inductive sensor coils for use in positioning the inductive coupling member such that it is aligned with and positioned in close proximity to the fixed ground mounted inductive charging point.

According to a second aspect of the invention there is provided a method for replenishing energy in an energy storage device of a motor vehicle by inductive coupling with a fixed ground located inductive charging point wherein the method comprises manoeuvring the motor vehicle so as to position it in a general location of a fixed charging point, using a sensor system to locate the position of the fixed charging point relative to a predefined location on the motor vehicle, using a three dimensional positioning mechanism to move an inductive coupling member supported by the positioning mechanism to a position in which the inductive coupling member is aligned with and positioned in close proximity to the fixed charging point and connecting the energy storage device to the fixed charging point using inductive coupling so as to replenish the energy level of the energy storage device.

A general location of a fixed charging point may be a charging bay having a fixed charging point located on the ground within the charging bay.

The invention will now be described by way of example with reference to the accompanying drawing of which:

### BRIEF DESCRIPTION OF THE DRAWINGS

FIG. 1A is a schematic plan view of a motor vehicle showing a perfect alignment between a fixed charging point and a vehicle mounted inductive coupling member;

FIG. 1B is a schematic plan view of a motor vehicle showing the vehicle positioned too far forward so that perfect alignment between the fixed charging point and the vehicle mounted inductive coupling member is not present;

FIG. 1C is a schematic plan view of a motor vehicle showing the vehicle positioned too far to the right so that perfect alignment between the fixed charging point and the vehicle mounted inductive coupling member is not present;

FIG. 1D is a schematic plan view of a motor vehicle showing the vehicle positioned too far to the left and too far back so that perfect alignment between the fixed charging point and the vehicle mounted inductive coupling member is not present;

FIG. 1E is a schematic plan view of a motor vehicle showing the vehicle positioned at an angle so that its position is too far to the right and too far forward so that perfect alignment between the fixed charging point and the vehicle mounted inductive coupling member is not present;

FIG. 2 is a schematic underside view of a motor vehicle showing a first embodiment of an apparatus for use in aligning an inductive coupling member with a fixed charging point;

FIG. 3 is a schematic underside view of a motor vehicle showing a second embodiment of an apparatus for use in aligning an inductive coupling member with a fixed charging point;

FIG. 4 is a view similar to FIGS. 2 and 3 showing a first embodiment of a three dimensional positioning mechanism for use in positioning an inductive coupling member in close proximity to and in alignment with a fixed charging point;

FIG. 5 is a side view in the direction of arrow “V” on FIG. 4 of part of the positioning system shown in FIG. 4 showing the relationship between a fixed charging point and the inductive coupling member prior to final alignment and positioning;

FIG. 6 is a partial cross-sectioned end view showing a roller and guide used to moveably connect a first moveable carriage to an underside of the motor vehicle;

FIG. 7 is an end view of a roller and hanger used to moveably connect one end of the first moveable carriage to the guide on the underside of the motor vehicle;

FIG. 8 is a pictorial view of part of an actuator used to raise and lower the inductive coupling member;

FIG. 9 is a bottom view of a second embodiment of a three dimensional positioning mechanism;

FIG. 10 is a side view of the positioning mechanism shown in FIG. 9;

FIG. 11A is a schematic side view of the positioning mechanism shown in FIGS. 9 and 10 showing an inductive coupling member positioned by the positioning mechanism in a ‘stowed’ position;

FIG. 11B is a schematic side view of the positioning mechanism shown in FIGS. 9 and 10 showing the inductive coupling member positioned by the positioning mechanism in an ‘in-use’ position; and

FIG. 11C is a schematic underside view of part of a motor vehicle showing a zone of operation for the positioning mechanism shown in FIGS. 9 to 11B.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

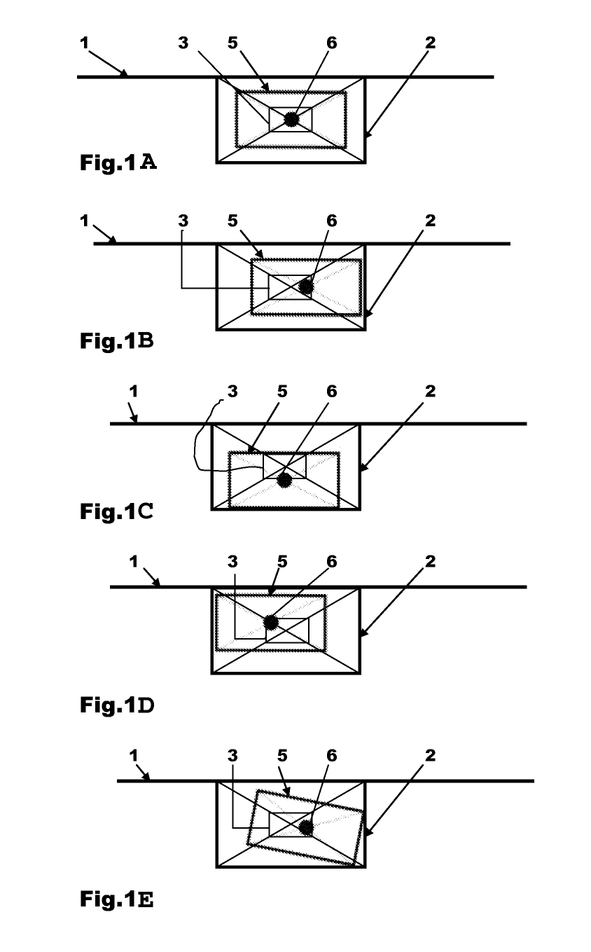

With reference to FIGS. 1A to 1E there is shown a road bounded by a curb 1 and a charging bay 2 located so as to extend in a lengthwise direction along the curb 1. The charging bay 2 has a centrally located fixed charging point 3 that is indicated as a large rectangle in FIGS. 1A to 1E but in practice would be of a smaller size. It will be appreciated that the orientation of the charging bay 2 could be different to that shown and that the invention is not limited to use with a charging bay 2 orientated as shown.

A motor vehicle 5 having a centrally mounted inductive coupling member 6 (shown as a black dot in FIGS. 1A to 1E) is shown located in various positions to illustrate the difficulty in correctly positioning the inductive coupling member 5.

Inductive coupling can occur within the bounds of the rectangle 3 but efficient inductive coupling will only occur when the inductive coupling member 6 is perfectly aligned with the centre of the rectangle as shown in FIG. 1A.

In FIG. 1B the motor vehicle 5 is positioned too far forward in the charging bay 2 so that perfect alignment between the fixed charging point 3 and the vehicle mounted inductive member 6 is not obtained, in FIG. 1C the motor vehicle 5 is positioned too far to the right in the charging bay 2 so that perfect alignment between the fixed charging point 3 and the vehicle mounted inductive coupling member 6 is not obtained, in FIG. 1D the motor vehicle 5 is positioned too far to the left and too far back in the charging bay 2 so that perfect alignment between the fixed charging point 3 and the vehicle mounted inductive coupling member 6 is not obtained and in FIG. 1E the motor vehicle 5 is positioned at an angle in the charging bay 2 so that its position is too far to the right and too far forward and perfect alignment between the fixed charging point 3 and the vehicle mounted inductive coupling member 6 is not obtained.

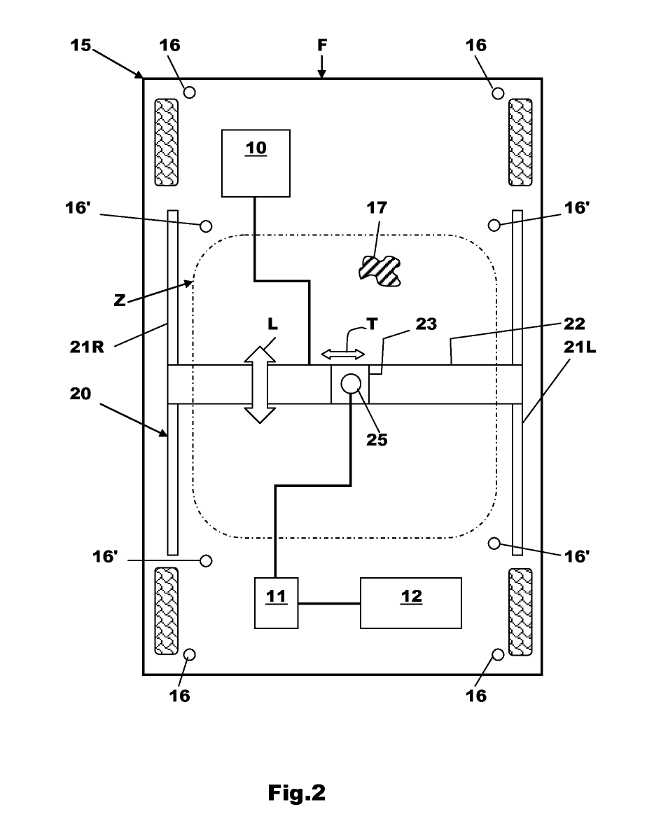

Referring now to FIG. 2 there is shown a motor vehicle 15 having a front end indicated by the arrow “F”.

The motor vehicle 15 has four road wheels and includes a source of motive power and drivetrain (not shown) to drive the motor vehicle 15 along a road.

The motor vehicle 15 includes a three dimensional positioning mechanism 20 located on an underside of the motor vehicle 15 for moving an inductive coupling member 25 in three directions relative to a floor 17 of the motor vehicle 15. The three directions are forward and back in a longitudinal direction of the motor vehicle 15, left and right in a transverse direction of the motor vehicle 15 and up and down in a vertical direction of the motor vehicle 15 from the underside of the motor vehicle 15 to the ground upon which the motor vehicle 15 is resting.

The positioning mechanism 20 includes a first carriage 22 moveable in a longitudinal direction of the motor vehicle 15 as indicated by the double arrow “L” on FIG. 2, a second carriage 23 mounted on the first carriage 22 for movement in a transverse direction of the motor vehicle 15 as indicated by the double arrow “T” on FIG. 2 and a lift mechanism attached to the second carriage 23 to vary the vertical position of the inductive coupling member 25. The lift mechanism to vary the vertical position could be a lever arm mechanism or could be an extendable ram. It will be appreciated that the lift mechanism need not move the inductive coupling member 25 in a purely vertical direction it merely has to move the inductive coupling member 25 from a position where it is stowed adjacent an underside surface of the floor 17 to and in-use position where it is positioned on or very close to a fixed charging point on the ground. That is to say, change the vertical position of the inductive coupling member 25.

A pair of longitudinally extending guides 21R, 21L is attached to the underside of the floor 17 for moveably supporting the first carriage 22.

The second carriage 23 is moveably supported on the first carriage 22 which is the form of a beam spanning between the two guides 21R, 21L.

Actuators (not shown) are provided to move the first carriage 22 relative to the floor 17 along the guides 21R, 21L, the second carriage 23 along the first carriage 22 and the inductive coupling member 25 up and down relative to the second carriage 23. The inductive coupling member 25 can be positioned on the underside of the motor vehicle 15 within a zone of operation ‘Z’ as indicated by the chain dotted line on FIG. 2.

The actuators for the first and second carriages 22 and 23 and the actuator or actuators for the lift mechanism are all controlled by an electronic controller 10 in response to signals received from a number of spaced apart inductive sensors 16 operatively connected to the electronic controller 10. In this example four inductive sensors are shown positioned towards the four corners of the motor vehicle 15 but in other examples the four inductive sensors could be more centrally located as indicated by the sensors 16′ or there could be both sets of sensors 16, 16′ present. In other examples only three inductive sensors could be used or more than four sensors could be used.

In all cases each sensor includes a coil that is used to sense the magnitude of inductive coupling at its location. The signals from the inductive sensors 16 or 16′ are used by the electronic controller 10 to determine the current location of the fixed charging point relative to a known point. The known point in this case is the current position of the inductive coupling member 25.

The current position of the inductive coupling member 25 is known at all times because the positioning mechanism 20 also includes a position feedback system (not shown) that uses a number of sensors associated with the first and second carriages 22 and 23 and the lift height mechanism to provide outputs indicative of the current position of the inductive coupling member 25.

The inductive coupling member 25 is connected via a charge controller 11 to an energy storage device 12.

The energy storage device 12 can be in the form of one or more batteries or other devices capable of storing electrical energy or can be a composite electrical/mechanical energy storage device such as a high speed motor/flywheel such as, for example, the high speed motor/flywheels manufactured by Williams Hybrid Power Ltd.

In the latter case electrical energy is provided to an electric motor to increase the speed of the flywheel thereby replenishing the kinetic energy stored in the flywheel. The stored kinetic energy can be extracted at a later time either by using the flywheel to be coupled to part of the drivetrain of the motor vehicle 15 or by using the flywheel to drive the electric motor as a generator and then supplying electrical energy from the generator to one or more electrical circuits on the motor vehicle such as, for example, an electric traction motor.

Operation of the motor vehicle 15 for replenishing the energy stored in the energy storage device 12 is as follows.

Firstly, the driver of the motor vehicle 15 locates a charging bay such as the charging bay shown in FIGS. 1A to 1E. The driver then parks the motor vehicle 15 in the charging bay or, if available on the motor vehicle 15, uses a parking assist system to park the motor vehicle 15 in the charging bay. The driver then initiates replenishment of the energy storage device 12 by operating a human machine interface which could be a switch or a touch screen device or any other HMI device arranged for this purpose.

Once replenishment is initiated, the electronic controller 10 is operable to control the position of the three dimensional positioning mechanism 20 in response to the signals received from the inductive sensors 16 or 16′ using triangulation techniques and the current position of the inductive coupling member 25. For example, if the outputs from the four sensors 16 indicate that the fixed charging point is located on the central longitudinal axis of the motor vehicle 15 a distance of 0.5 m forward from the current position of the inductive coupling member 25 currently also located on the central longitudinal axis of the motor vehicle 15 then the first carriage 22 is moved by the actuator or actuators associated with it forward a distance of 0.5 m and the inductive coupling member 25 is then lowered down so as to be aligned with the fixed charging point. Preferably the inductive coupling member 25 is positioned on the fixed charging point with no air-gap. A similar process is followed for any other fixed charging point location within the zone of operation Z of the positioning mechanism 20.

If the fixed charging point is determined by the inductive sensors 16 or 16′ to be located outside of the zone of operation Z of the positioning mechanism 20 then the electronic controller 10 is operable to provide a warning to the driver of the motor vehicle 15 that replenishing of the energy storage device is not possible due to vehicle misalignment. This warning could be via the illumination of a warning lamp or via an alpha numeric message on a display. In the latter case guidance as to the required action could also be given such as, for example, “Go forward”, “Go back”, “Go left”, “Go right”.

With this embodiment the alignment of the inductive coupling member 25 with the fixed charging point is in most respects fully automatic unless the vehicle 15 is so poorly positioned that the fixed charging point falls outside the zone of operation Z of the positioning mechanism.

When it is determined that the inductive coupling member 25 is correctly aligned and positioned relative to the fixed charging point then the charge controller 11 connects the inductive coupling member 25 to the energy storage device 12 so that the energy level of the energy storage device 12 can be replenished.

The charge controller 11 is operable to monitor the energy level of the energy storage device 12 during replenishment and when it reaches a predefined level will terminate the flow of electrical energy from the fixed charging point to the energy storage device 12. The inductive coupling member 25 is then returned to its stowed position by the electronic controller 10.

It will be appreciated that if the energy storage device is one or more batteries then ‘replenishment’ will comprise charging of the battery or batteries.

The charge controller 11 is also operable to monitor the energy level in the energy storage device 12 during normal use of the motor vehicle 15 and alert the driver if the level of energy stored in the energy storage device 12 falls below a predefined level. The charge controller may also or additionally provide a continuous output of the level of energy stored in the energy device 12 in a manner similar to that of a fuel gauge in a conventional gasoline motor vehicle.

The inductive sensors 16, 16′ could be supplemented by a number of sensor coils located on the inductive coupling member 25 and connected to the electronic controller 10. Such an arrangement is disclosed in US patent publication 2013/0033224 and a sensor arrangement such as this could be used to facilitate fine tuning of the position of the inductive coupling member 25 once it has been positioned close to the fixed charging point by using the outputs from the sensor coils located on the inductive coupling member 25 to align the inductive coupling member 25 with the fixed charging point.

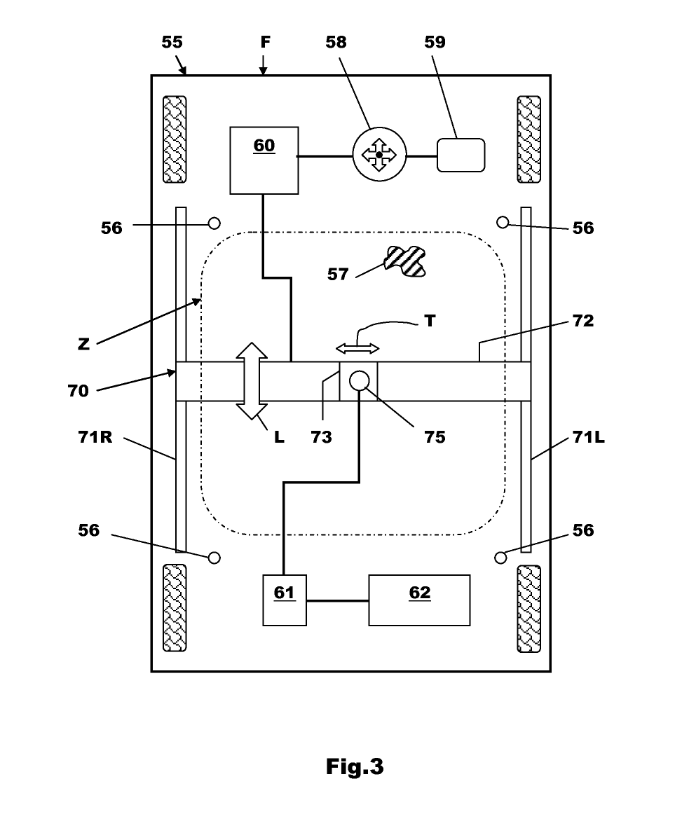

With reference to FIG. 3 there is shown a second embodiment of a motor vehicle 15 having a front end indicated by the arrow “F”.

The motor vehicle 55 has four road wheels and includes a source of motive power and a drivetrain (not shown) to drive the motor vehicle 55 along a road.

The motor vehicle 55 includes a three dimensional positioning mechanism 70 located on an underside of the motor vehicle 55 for moving an inductive coupling member 75 in three directions relative to a floor 57 of the motor vehicle 55. The positioning mechanism 70 is normally fastened to the floor 57 of the motor vehicle 55 but alternatively parts of the motor vehicle structure could be used to support the positioning mechanism 70 underneath the motor vehicle 55.

The positioning mechanism 70 includes a first carriage 72 moveable in a longitudinal direction of the motor vehicle 55 as indicated by the double arrow “L” on FIG. 3, a second carriage 73 mounted on the first carriage 72 for movement in a transverse direction of the motor vehicle 55 as indicated by the double arrow “T” on FIG. 3 and a lift mechanism attached to the second carriage 73 to vary the vertical position of the inductive coupling member 75. The lift mechanism could be a lever arm mechanism or could be an extendable ram. It will be appreciated that the lift mechanism is operable to change the vertical position of the inductive coupling member 75 from a position where it is stowed adjacent an underside surface of the floor 57 to and in-use position where it is positioned on or very close to a fixed charging point on the ground.

A pair of longitudinally extending rails or guides 71R, 71L is attached to the underside of the floor 57 for moveably supporting the first carriage 72.

The second carriage 73 is moveably supported on the first carriage 72 which is the form of a beam spanning between the two guides 71R, 71L.

Actuators (not shown) are provided to move the first carriage 72 relative to the floor 57 along the guides 71R, 71L, the second carriage 73 along the first carriage 72 and the inductive coupling member 75 up and down relative to the second carriage 73. The inductive coupling member 75 can be positioned on the underside of the motor vehicle 55 within a zone of operation ‘Z’ as indicated by the chain dotted line on FIG. 3.

The actuators for the first and second carriages 72 and 73 and for the lift mechanism are controlled by an electronic controller 60 in response to a control input received from a human machine interface which in this case is in the form of a joystick 58.

A number of spaced apart wide angle cameras 56 are positioned close to but outside of the zone of operation Z of the positioning mechanism 70. In other embodiments only three cameras could be used or more than four cameras could be used. Each of the cameras 56 includes a source of light such as, for example, a light emitting diode array to illuminate an area in front of the respective camera 56.

The signals from the cameras 56 are used to determine the location of the fixed charging point relative to the inductive coupling member 75. The position of the inductive coupling member 75 can be estimated from the images produced by the cameras 56.

The signals from the four cameras 56 are displayed either as separate images or as a composite image on a display device 59. The display device 59 could be the same device used to display an image from a reversing or back-up camera or could be a bespoke display.

The driver of the motor vehicle 55 is able using the joystick 58 to move the inductive coupling member 25 from its current position to the position of the fixed charging point and guidance could be provided on the display screen 59 to assist with this manoeuvring of the inductive coupling member 25.

When the inductive coupling member 25 is positioned above the fixed charging point the driver operates a push button or other control to lower the inductive coupling member 25 onto the fixed charging point.

As a refinement to this embodiment, the cameras 56 could be supplemented by a number of sensor coils located on the inductive coupling member 75 and connected to the electronic controller 60. Such an arrangement is disclosed in US patent publication 2013/0033724. Such a sensor arrangement could be used to facilitate fine tuning of the position of the inductive coupling member 75 once it has been positioned close to the fixed charging point using the cameras 56. This could be done by providing specific guidance on the display 59 based upon the respective signal levels from the sensor coils on the inductive coupling member 25. For example an arrow or text could be displayed indicating the direction that the inductive coupling member 25 needs to be moved.

It will be appreciated that the cameras 56 could be supplemented by or replaced by one or more cameras in alternative locations to those shown in FIG. 3. For example and without limitation, one or more cameras could be mounted on the inductive coupling member 75 and/or on the second carriage 73.

The inductive coupling member 75 is connected via a charge controller 61 to an energy storage device 62.

The energy storage device 62 can be in the form of one or more batteries or other devices capable of storing electrical energy or can be a composite electrical/mechanical energy storage device such as a high speed motor/flywheel as referred to above.

Operation of the motor vehicle 55 for replenishing the energy stored in the energy storage device 62 is as follows.

Firstly, the driver of the motor vehicle 55 locates a charging bay such as the charging bay shown in FIGS. 1A to 1E. The driver then parks the motor vehicle 55 in the charging bay or, if available on the motor vehicle 55, uses a parking assist system to park the motor vehicle in the charging bay. The driver then initiates replenishment of the energy storage device 62 by operating a human machine interface which could be a switch or a touch screen device or any other HMI device arranged for this purpose which could include the display 59.

The electronic controller 60 is then operable to control the position of the three dimensional positioning mechanism 70 in response to the control input or signals received from the joystick 58.

If the fixed charging point is determined by the cameras 56 to be located outside of the zone of operation Z of the positioning mechanism 70, then replenishing of the energy storage device 62 is not possible due to vehicle misalignment. That is to say, if the fixed charging point is not visible to any of the cameras 56 then replenishing cannot take place.

With this embodiment the alignment of the inductive coupling member 75 with the fixed charging point is in most respects possible by the direct control of the driver unless the vehicle 55 is so poorly positioned that the fixed charging point falls outside the zone of operation Z of the positioning mechanism.

When it is determined that the inductive coupling member 75 is correctly aligned and positioned relative to the fixed charging point then the charge controller 61 connects the inductive coupling member 75 to the energy storage device 62 so that the energy level of the energy storage device 62 can be replenished.

The charge controller 61 is operable to monitor the energy level of the energy storage device 62 during replenishment and, when it reaches a predefined level, the charge controller 61 terminates the flow of electrical energy from the fixed charging point to the energy storage device 62. The inductive coupling member 75 is then returned to its stowed position either automatically by the electronic controller 60 or manually by the driver of the motor vehicle 55.

The charge controller 61 is also operable to monitor the energy level in the energy storage device 62 during normal use of the motor vehicle 55 and alert the driver when the level of energy in the energy storage device 62 falls below a predefined level.

The charge controller 61 may also provide a continuous output of the level of energy stored in the energy storage device 62 in a manner similar to that of a fuel gauge in a conventional gasoline or diesel motor vehicle.

As an alternative embodiment to the above described embodiments, an inductive coupling member having a number of sensor coils such as that shown in US Patent publication 2013/0033224 could be used to locate the fixed charging point. This can be achieved by using a three dimensional positioning system to move the inductive coupling member in a predefined search pattern and monitoring the outputs from the sensor coils. The outputs from the sensor coils on the inductive coupling member are used during this search phase to locate the general position of the fixed charging point. The inductive coupling member is then accurately positioned by using the positioning mechanism to move the inductive coupling member slowly in response to variations in signal strength produced by the sensor coils until correct alignment with the fixed charging point is achieved.

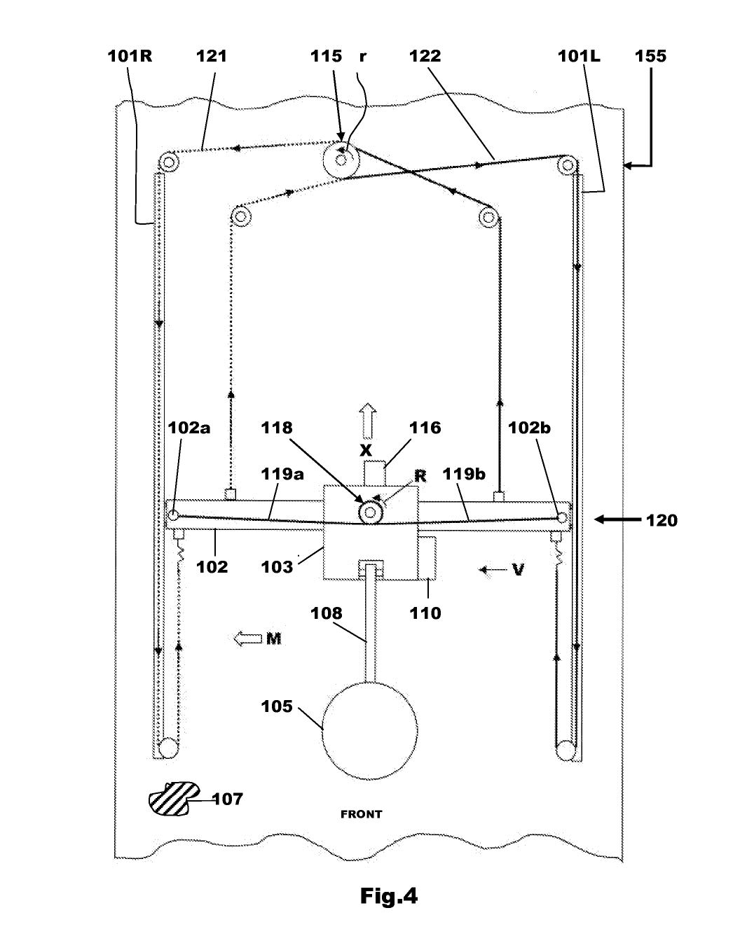

With reference to FIGS. 4 to 8 there is shown one embodiment of a three dimensional positioning mechanism for use in a motor vehicle as shown in FIGS. 2 and 3.

The three dimensional positioning mechanism 120 is operable to move an inductive coupling member 105 in three directions relative to a floor 107 of a motor vehicle to which it is attached.

The positioning mechanism 120 includes a first carriage 102 moveable in a longitudinal direction of the motor vehicle, a second carriage 103 mounted on the first carriage 102 for movement in a transverse direction of the motor vehicle and a lever mechanism 108, 109 pivotally attached to the second carriage 103 to vary the vertical position of the inductive coupling member 105.

The lever mechanism comprises a first guide arm 108 and a second actuator arm 109 and forms in combination with the second carriage 103 and a support part 105m of the inductive coupling member 105 a four bar linkage that maintains the inductive coupling member 105 substantially horizontal irrespective of its vertical position.

A pair of longitudinally extending C-shaped guides 101R, 101L is attached to the underside of the floor 107 for moveably supporting the first carriage 102.

The second carriage 103 is moveably supported on the first carriage 102 by a number of linear roller bearings 103b interposed between the second and third carriages 102 and 103.

The first carriage 102 is the form of a tubular beam spanning between the two guides 101R, 101L. At each end the second first carriage 102 a hanger plate 127 is attached to rotatably support a pair of spaced apart rollers or guide wheels 128. Each pair of guide wheels 128 is engaged with a respective one of the guides 101R, 101L as can best been seen in FIG. 6.

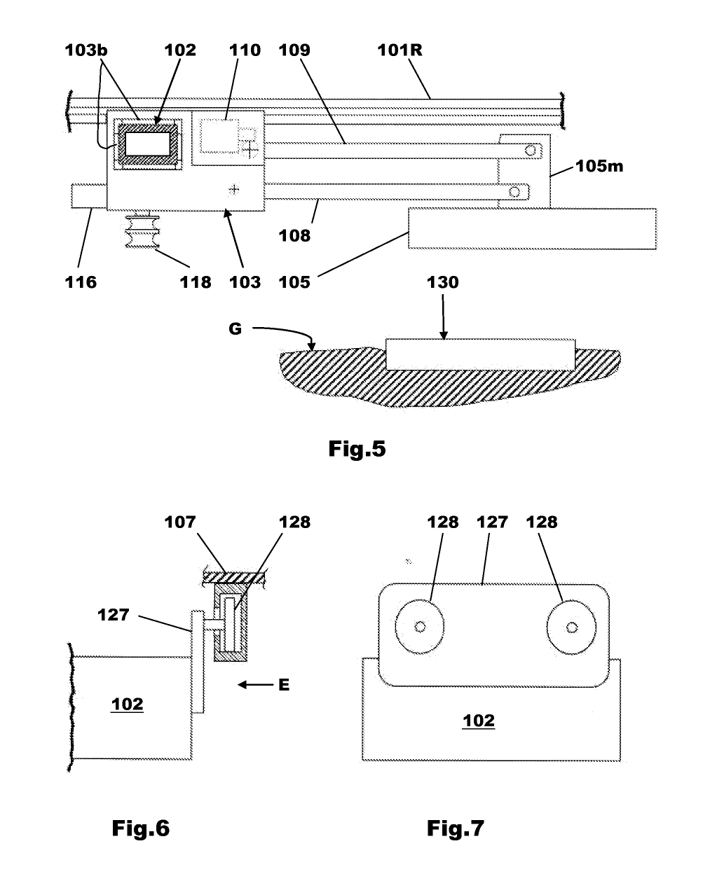

Actuators are provided to move the first carriage 102 relative to the floor 107 along the guides 101R, 101L, the second carriage 103 along the first carriage 102 and the inductive coupling member 105 up and down relative to the ground “G” (FIG. 5) upon which the motor vehicle is resting.

The actuator for the first carriage 102 comprises an electric motor driving a double pulley 115 driving first and second cable drives 121, 122.

The first cable drive 121 has a cable attached at both ends to the first carriage 102 near to its right hand end and trained around respective pulley guides located near to front and rear ends of the right hand side guide 101R.

The second cable drive 122 has a cable attached at both ends to the first carriage 102 near to its left hand end and trained around respective pulley guides located near to front and rear ends of the left hand side guide 101L.

If the motor rotates the double pulley 115 in the direction indicated by the arrow “r” on FIG. 4, the first carriage 102 moves in the direction of the arrow “X” on FIG. 4. Rotation of the double pulley 115 in an opposite direction will result in the second carriage moving in the reverse direction towards the front of the motor vehicle.

An actuator means for the second carriage 103 comprises an electric motor 116 driving a double pulley 118 via a worm drive (not shown). Two cables 119a, 119b are wrapped around the double pulley 118 in opposite directions. A first one of the cables 119a is fastened at one end to the first carriage 102 near to its right hand end by an anchor 102a and at an opposite end to the double pulley 118. A second one of the cables 119b is fastened at one end to the first carriage 102 near to its left hand end by an anchor 102b and at an opposite end to the double pulley 118.

If the double pulley 118 is rotated in the direction indicated by the arrow “R” on FIG. 4 then the second carriage 103 will move in the direction of the arrow “M on FIG. 4 and vice-versa.

An actuator for the lever arm mechanism comprises an electric motor 110 which drives via a worm drive 129 a shaft 109s fixed to the actuator arm 109.

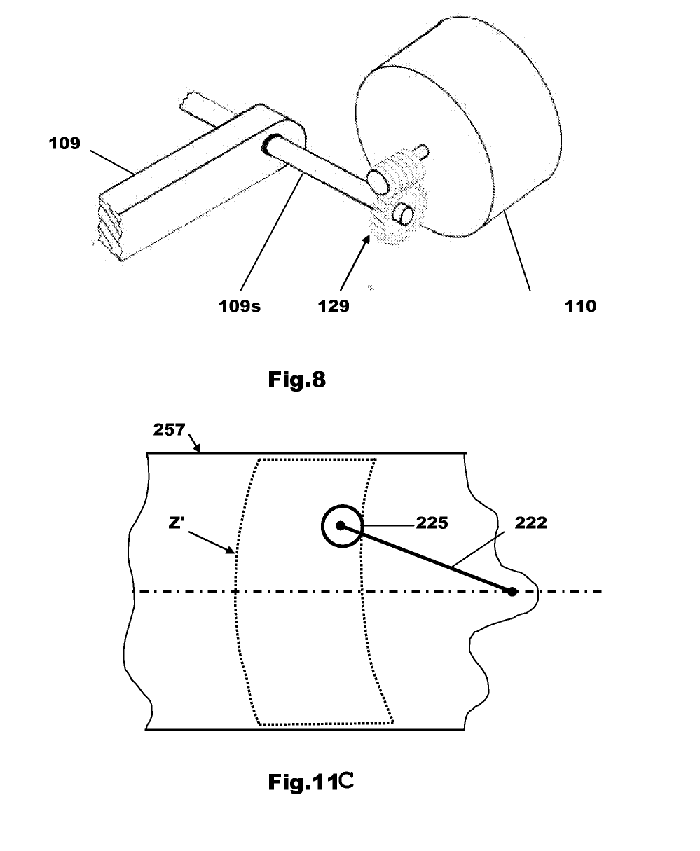

When the motor 110 rotates in a raising direction the shaft 109s rotates in a clockwise direction as viewed in FIG. 8 thereby raising the actuator arm 109 and the inductive coupling member 105. When the shaft 109s is rotated in a counter-clockwise direction by the motor 110 the inductive coupling member 105 is lowered.

In FIG. 5 the inductive coupling member 105 is shown in a raised or stowed position and is located above a fixed charging point 130 that is located on the ground “G” upon which the motor vehicle is resting. When the motor 110 rotates in a lowering direction the inductive coupling member 105 will be lowered so as to rest upon the fixed charging point 130.

The means used to control and position the inductive coupling member 105 are as previously described and include an electronic controller to control the operation of the three actuators. It will be appreciated that sensors are used on the actuators to provide feedback from which the actual position in three dimensions of the inductive coupling member 105 can be determined.

Although the positioning mechanism 120 shown utilises a cable drive system for the first and second carriages 102 and 103 it will be appreciated that other drive means could be used. For example and without limitation, linear motors could be used to move the first carriage 102 along the guides 101R, 101L and a further linear motor can be used to move the second carriage 103 along the first carriage 102.

As yet another alternative, electric motors could be used to power rack and pinion gear drives located between the first carriage 102 and the guides 101R, 101L and between the second carriage 103 and the first carriage 102. In such an embodiment a toothed track is attached to each of the guides 101R, 101L for engagement with a respective gear wheel driven by electric motors mounted on the first carriage 102. Similarly, a toothed track is fastened to the first carriage 102 for engagement with a gear wheel driven by an electric motor mounted on the second carriage 103.

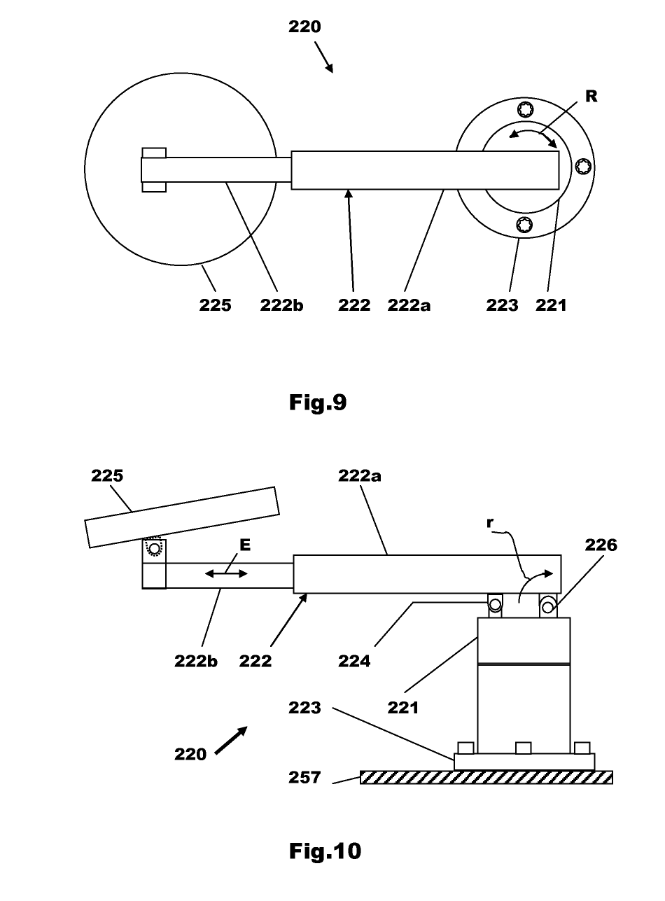

With reference to FIGS. 9 to 11C an alternative embodiment of a three dimensional positioning mechanism 220 is shown that could be used as a replacement for the positioning mechanism shown in FIGS. 2 and 3.

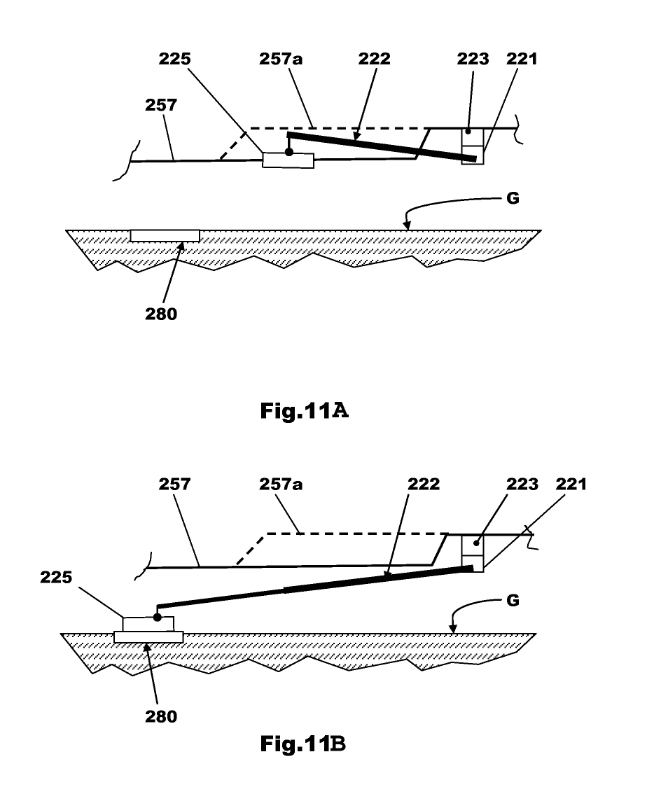

The positioning mechanism 220 comprises a turret member 221 rotatably mounted on a base member 223 used to fasten the positioning mechanism to an underside of a floor 257 of a motor vehicle to which the positioning mechanism 220 is fitted. FIG. 10 shows the positioning mechanism 220 upside down from its operational position which is shown correctly orientated in FIGS. 11A and 11B.

An extendable arm 222 is attached at one end to the turret 221 by means of a pivotal connection 226 and an actuator ram 224. When the ram 224 is extended the extendable arm 222 is rotated relative to the turret 221 about the pivotal connection 226 in the direction indicated by the arrow ‘r’ on FIG. 10 so as to move a inductive coupling member 225 towards the ground “G” upon which the motor vehicle is resting. When the ram 224 is retracted the extendable arm 222 is rotated about the pivotal connection 226 in a direction opposite to that indicated by the arrow ‘r’ on FIG. 10 so as to move the inductive coupling member 225 away from the ground “G”.

The inductive coupling member 225 is connected to an outer end of an outer arm 222b which is slidingly supported at an inner end by a tubular inner arm 222a. The inner and outer arms 222a and 222b form in combination the extendable arm 222. In this embodiment the extendable arm 222 is in the form of a double acting hydraulic ram. A piston (not shown) is attached to the inner end of the outer arm 222b. By supplying pressure to an inboard side of the piston the outer arm 222b is pushed out of the inner arm 222a so as to increase the length of the extendable arm 222 and vice versa. The outer arm 222b can therefore be extended or contracted as indicated by the double headed arrow “E” on FIG. 10 by adjusting the pressure differential subsisting across the piston. It will be appreciated that the extendable arm could comprise of more than two arms and that other means to extend and retract the arms could be used.

The turret 221 is rotatable about a substantially vertical axis as indicated by the double headed arrow “R” on FIG. 9. Rotation of the turret 221 relative to the base member 223 is performed by a rotary actuator housed with the base member 223 in the form of an electric motor (not shown) having a spur gear fastened to an output shaft of the electric motor driving a ring gear (not shown) fastened to the turret 221. It will be appreciated that the base member 223 includes bearing means (not shown) to rotatably support the turret 221 on the base member 223.

A zone of operation ‘Z’ for the positioning mechanism is shown schematically in FIG. 11C. It will be appreciated that the zone of operation ‘Z’ in this case comprises of two arcs corresponding to retracted and extended positions of the extendable arm 222 joined together by straight lines arranged adjacent to and parallel with the outer edges of the floor 257. However, it will be appreciated that the turret 221 could be arranged to rotate through 360 degrees so that the zone of operation would then comprises of an annular area.

Operation of the positioning mechanism 220 is best understood with reference to FIGS. 11A and 11B.

In FIG. 11A the positioning mechanism 220 is shown with the inductive coupling member 225 in a stowed or raised position.

In this state the retractable arm 222 is fully retracted and the inductive coupling member 225 is positioned within a depression or recess 257a formed in the floor 257 of the motor vehicle. The base member 223 is fastened under the floor 257 which is stepped up so as to reduce the amount that the turret 221 projects below the level of the main portion of the floor 257. The stepped up portion of the floor could in the case of a passenger motor vehicle be a floor of a luggage compartment of a motor vehicle and the step in the floor could be positioned in the region of a rear bulkhead (not shown) separating a passenger compartment (not shown) of the motor vehicle from a luggage space (not shown).

A fixed charging point 280 is shown recessed into the ground “G” upon which the motor vehicle is resting. It will be appreciated that the fixed charging point 280 could alternatively be arranged to be fastened on top of the ground “G” in which case it would project upwardly from the ground “G” rather than be substantially flush with the ground “G” as shown in FIGS. 11A and 11B.

In FIG. 11B the inductive coupling member 225 is shown in an in-use position in which it is aligned with and is positioned on the fixed charging point 280 so that no significant air gap is present therebetween. As shown the fixed charging point 280 is located at the maximum reach of the positioning mechanism 220. That is to say, the fixed charging point is located at a front boundary of the zone of operation ‘Z’ of the positioning mechanism 220. In this position the extendable arm 222 is fully extended and the ram 224 is extended so as to position the inductive coupling member 225 close to the ground “G” in alignment with the fixed charging point 280. Preferably there is no air-gap between the inductive coupling member 225 and an upper surface of the fixed charging point 280.

It will be appreciated that the inductive coupling member 225 can be located in an in-use position anywhere within the zone of operation ‘Z’ of the positioning mechanism and so the extendable arm 222 does not have to be fully extended for the inductive coupling member 225 to be positioned in the ‘in-use’ position.

A control system having sensors and at least one electronic controller is used to control the positioning mechanism 220 as described previously with reference to FIGS. 2 and 3.

It will be appreciated that the apparatus described herein is useful for any type of road vehicle requiring the replenishment of energy in an energy storage device by means of inductive coupling with a fixed ground located charging point.

It will be appreciated that the three dimensional positioning mechanism could be located at any suitable position on the motor vehicle.

Although in the described embodiments the zone of operation is always within the periphery of the motor vehicle it will be appreciated that this need not be the case and that the positioning mechanism could be constructed to facilitate coupling with a fixed charging point outside the periphery of the motor vehicle.

It will also be appreciated that the two embodiments disclosed herein could be combined by mounting a turret and extendable arm arrangement as shown in FIGS. 9 to 11C on the second carriage shown in FIGS. 2 to 4 to replace the support arms for the inductive coupling member. Such an arrangement is particularly advantageous if it is required to facilitate use of the positioning mechanism for coupling with a charging point located outside the periphery of the motor vehicle.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A motor vehicle comprising:
an inductive charging system including an inductive coupling member and a three dimensional positioning mechanism arranged to support the inductive coupling member and operable to position the inductive coupling member so that the inductive coupling member is aligned with and positioned in close proximity to a fixed charging point so as to facilitate replenishment of an energy storage device of the vehicle via the inductive coupling member.

2. The vehicle as claimed in claim 1 wherein the positioning mechanism includes a first carriage moveable in a longitudinal direction of the motor vehicle, a second carriage mounted on the first carriage for movement in a transverse direction of the motor vehicle and a lift mechanism attached to the second carriage to vary a vertical position of the inductive coupling member.

3. The vehicle as claimed in claim 2 wherein the mechanism to vary the vertical position of the inductive coupling member comprises at least one arm pivotally connected at one end to the second carriage and connected at an opposite end to the inductive coupling member.

4. The vehicle as claimed in claim 2 wherein the mechanism comprises a pair of arms each of which is pivotally connected at a respective one end to the second carriage and connected at a respective opposite end to the inductive coupling member so as to form in combination with the second carriage and the inductive coupling member a four bar linkage.

5. The vehicle as claimed in claim 1 wherein the positioning mechanism comprises a rotatable turret and at least one extendable arm pivotally connected at one end to the rotatable turret and connected at an opposite end to the inductive coupling member.

6. The vehicle as claimed in claim 1 wherein the vehicle further comprises at least three induction sensors positioned at known positions on an underside of the vehicle and an electronic controller arranged to receive outputs from the induction sensors and determine using outputs of the sensors the position of the fixed charging point relative to a current position of the inductive coupling member.

7. The vehicle as claimed in claim 6 wherein the electronic controller is further operable to provide one or more control outputs to actuators formed as part of the three dimensional positioning mechanism for use in controlling the position of the inductive coupling member.

8. The vehicle as claimed in claim 7 wherein the electronic controller is operable when requested to move the inductive coupling member towards the fixed charging point.

9. The vehicle as claimed in claim 1 wherein the vehicle further comprises at least three cameras positioned on an underside of the vehicle, a display screen to display outputs from the cameras and a human machine interface to provide a control input to an electronic controller arranged to control the position of the inductive coupling member in response to the input from the human machine interface.

10. The vehicle as claimed in claim 9 wherein the electronic controller is operable to provide control outputs to actuators formed as part of the three dimensional positioning mechanism in order to control the position of the inductive coupling member.

11. The vehicle as claimed in claim 1 wherein the inductive coupling member includes a number of inductive sensor coils for use in positioning the inductive coupling member such that it is aligned with and positioned in close proximity to the fixed charging point.

12. A method for replenishing energy in an energy storage device of a motor vehicle by inductive coupling with a fixed ground located inductive charging point wherein the method comprises manoeuvring the motor vehicle so as to position it in a general location of a fixed charging point, using a sensor system to locate the position of the fixed charging point relative to a predefined location on the motor vehicle, using a three dimensional positioning mechanism to move an inductive coupling member supported by the positioning mechanism to a position in which the inductive coupling member is aligned with and positioned in close proximity to the fixed charging point and connecting the energy storage device to the fixed charging point using inductive coupling so as to replenish an energy level of the energy storage device.

13. The method as claimed in claim 12 wherein the general location of a fixed charging point is a charging bay having a fixed charging point located on ground within the charging bay.
